(19) United States
(12) Patent Application Publication
(10) Pub. No.: US 2013/0299361 A1
(43) Pub. Date: Nov. 14, 2013

(54) System and Method for Treatment of Wastewater to Destroy Organic Contaminants by a Diamond Activated Electrochemical Advanced Oxidation Process

(71) Applicant: Advanced Diamond Technologies, Inc., Romeoville, IL (US)

(72) Inventors: Ian Wylie, Naperville, IL (US); John A. Carlisle, Plainfield, IL (US); Prabhu Arumugam, Naperville, IL (US)

(21) Appl. No.: 13/890,050

(22) Filed: May 8, 2013

Related U.S. Application Data
(60) Provisional application No. 61/644,392, filed on May 8, 2012.

(51) Int. Cl. C02F 1/461

(52) U.S. Cl. CPC C02F 1/461
USPC 205/755; 204/273

(57) ABSTRACT

Disclosed is a system and method for treatment of wastewater to destroy organic contaminants using an electrochemical advanced oxidation process. In particular, the method comprises a multistep process, comprising a) generating a concentrated oxidant solution comprising a peroxy oxidant species, such as persulfate or hydrogen peroxide; b) mixing wastewater comprising organic contaminants with the concentrated oxidant solution to provide a mixture comprising wastewater and diluted oxidant, the wastewater and concentrated oxidant solution being mixed in a prescribed ratio to provide a desired concentration ratio of oxidant species to contaminants; and c) in an electrochemical cell comprising a diamond anode, electrolyzing the mixture of wastewater and diluted oxidant, comprising electrochemically activating the peroxy oxidant species for oxidation and destruction of the contaminants. Fast and effective destruction of organic contaminants such as phenol, napthenic acid and other toxic or refractory contaminants is demonstrated at low cost and with reduced usage of added salt.

### CROSS-REFERENCE TO RELATED APPLICATION

This application claims priority from U.S. provisional patent application Ser. No. 61/644392 entitled “Diamond Activated Electrochemical Advanced Oxidation Processes”, filed May 8, 2012, which is incorporated herein by reference, in its entirety.

### TECHNICAL FIELD

This invention relates to methods for treatment of wastewater to destroy organic contaminants by electrochemical advanced oxidation processes.

### BACKGROUND ART

The recent dramatic increase in the use of hydraulic fracturing (“fracking”) and horizontal drilling in low permeability shale formations for the production of oil and natural gas (“tight oil and gas”) has caused a dramatic increase in water usage and in requirements for treating wastewater. The EPA estimates that between 1.7-3.0 million barrels (300-600 million tonnes) of water are currently used each year in the US for the fracking of ˜35,000 wells. This huge increase in water use and wastewater treatment is being driven by a combination of higher water use per well (˜50-250 thousand barrels of water per well are typical for fracking operations, which is at least an order of magnitude greater than older drilling methods) and by an increase in the number of wells. As much as 80% of the water from a drilling operation along with the fracking chemicals added to it, return to the surface and must be treated or re-injected into deep wells to avoid groundwater contamination. This water can contain a wide array of hazardous fracking chemicals, e.g. methanol, benzene, phenols, isopropyl alcohol, acrylates, and naturally-occurring organics such as napthenic acids, benzene, methane, phenols, organosulfur compounds and other hydrocarbons. Another example of this type of wastewater is the “Tailing Pond Water” generated from oilsands hydrocarbon recovering in large quantities in Alberta, Canada, which is contaminated with a significant toxic load of napthenic acids (e.g. 50-100 ppm).

Despite the high economic value of fracking, many states are reluctant to expand fracking operations due to concerns about water contamination. It is therefore vital that more effective wastewater remediation technologies be developed for fracking and for other hydrocarbon recovery processes that produce large volumes of wastewater containing organic contaminants.

It is well known in the art that chemical oxidation or electrochemical oxidation of wastewater can be used for water purification or destruction of biological and chemical contaminants, both inorganics and organics.

For chemical oxidation, oxidants such a hypochlorite or persulfate may simply be added to the wastewater. During electrochemical treatment or oxidation of wastewater, it is usually required that sodium chloride or other salts are added to the wastewater, to provide sufficient conductivity for electrolysis, and for electrochemical production of an oxidant or sterilant species, such as chlorine. See for example, U.S. Pat. No. 6,328,875 entitled “Electrolytic apparatus, methods for purification of aqueous solutions and synthesis of chemicals” and U.S. Pat. No. 6,547,947 entitled “Method and apparatus for water treatment”, which discloses electrochemical generation of hydrogen peroxide and an oxidation product such as hypochlorite or persulfate for water treatment.

It is well known that persulfuric acid (H₂S₂O₈), or the anion of the acid, i.e. peroxodisulfate (S₂O₈²⁻) or persulfate, can provide more effective chemical destruction of some organic contaminants than chlorine or hypochlorite. Persulfates can be produced efficiently by electrolysis of sulfuric acid or sulfate salts, and then added to wastewater. See for example, U.S. Pat. No. 6,503,386 entitled “Process for the production of alkali metal and ammonium peroxodisulfate”. This patent discloses the use of conductive diamond electrodes to provide longer life and better efficiencies in operating costs such as maintenance, for electrochemical production of persulfates.

While persulfate can chemically oxidize many organic molecules more effectively than hypochlorite, the process can be a very slow, resulting in a very time-consuming or expensive process. As an example, it will be apparent that a number of oxidation steps are necessary to oxidize a molecule such as phenol to small acids or carbonate. It is observed that persulfate added to wastewater oxidizes phenol and napthenic acid very slowly.

Thus, once the persulfate is produced electrochemically, activation is typically required to accelerate the oxidation reactions during wastewater treatment, both to provide more complete oxidative destruction of contaminants and to accelerate the reaction. In the past, ultraviolet radiation, application of heat and/or use of transitional metal catalysts have been primary methods of activation (Block; Philip, et al., “Novel Activation Technologies for Sodium Persulfate In Situ Chemical Oxidation”, 2004). The activation process can be very energy intensive and/or costly. It also tends to cause additional complexity in both the oxidative destruction process and in the treatment of the resultant wastes (e.g. insoluble ferric salts from the catalysts).

In considering electrochemical oxidation processes, a particular issue is that the large volumes of wastewater produced by processes for hydrocarbon recovery, such as fracking, may contain relatively low concentrations of contaminants, e.g. 10 ppm to 100 ppm or 500 ppm of contaminants such as, naphthenic acid and phenols. These contaminants can be destroyed by electrochemical oxidation, e.g. using persulfate or other oxidants activated using the methods mentioned above. However such wastewater has low conductivity, meaning that electrochemical treatment has to be carried out at a low current density, and the process is therefore slow and has low current efficiency (e.g. <10% current efficiency). Moreover, persulfate oxidants are not efficiently generated in situ from low concentrations of sulfuric acid or sulfate salts added to wastewater, i.e. requiring high energy costs per unit of contaminant for electrochemical destruction. Large quantities of salt can be added to wastewater to increase conductivity and current efficiency for electrochemical processing at higher current density, and in any case are necessary in order to increase conductivity and lower operating voltages for electrochemical treatment.

However, when there is a relatively low concentration of contaminants, the high total dissolved solids (TDS) in the treated wastewater may itself create other wastewater disposal issues, i.e. how to dispose of the salt water. Thus, it is usually desirable to avoid the need to add significant amounts of salt, so as to maintain low total dissolved solids, i.e. a low salt concentration, in treated wastewater.

Thus, there is a need for improved or alternative solutions which address one or more shortcomings of known methods and systems for wastewater treatment to destroy organic contaminants. In particular, alternative chemical or electrochemical processes for treatment of wastewater to destroy refractory organic contaminants, such as phenols and napthenic acids, are required for applications such as hydrocarbon recovery, e.g. in particular where the concentration of salts already present in the wastewater is relatively low (i.e. wastewater having low conductivity).

### SUMMARY OF INVENTION

The present invention seeks to mitigate the above mentioned problems, or at least provide an alternative system and method for wastewater treatment to destroy organic contaminants.

Thus one aspect of the present invention provides a method for treatment of wastewater to destroy organic contaminants, comprising:
a) generating a concentrated oxidant solution comprising a peroxy oxidant species;
b) mixing wastewater comprising organic contaminants with the concentrated oxidant solution to provide a mixture comprising wastewater and diluted oxidant solution, the wastewater and concentrated oxidant solution being mixed in a prescribed ratio; and
c) in an electrochemical cell comprising a diamond anode, electrolyzing the mixture of wastewater and diluted oxidant solution, comprising electrochemically activating the oxidant species for oxidation and destruction of the contaminants.

For destruction of contaminants such as phenol and napthenic acids, the peroxy oxidant species preferably comprises persulfate and/or hydrogen peroxide. In some embodiments the peroxy oxidant species may comprise alternative peroxy oxidant species such as, perborate or pyrophosphate.

The concentrated oxidant solution comprises persulfate or other peroxy oxidant species at a concentration that can provide a desired mole ratio relative to the concentration of a target organic contaminant to be oxidized when the concentrated solution is mixed with the wastewater in the prescribed ratio. For example, it may be required that the contaminant load is sufficiently reduced to a particular target level, e.g. to attain a particular Chemical Oxygen Demand (COD) level.

Preferably, step a) comprises generating the concentrated oxidant solution by electrolysis at high current density in an electrochemical cell comprising a diamond anode, from an aqueous solution containing ≧1M sulfate, e.g. >1M sulfuric acid, with salt added (0.5 to 2M) to increase conductivity and current efficiency. For example, persulfate may be generated with high current efficiency by electrolysis of sulfuric acid at high current density.

Step a) is preferably carried out at a high current density, e.g. in the range from 300 mA/cm² to 1000 mA/cm² or more preferably in the range from >500 mA/cm² to 1000 mA/cm².

The wastewater and concentrated oxidant solution are mixed in a ratio in the range from 5:1 to 25:1, for example in a ratio of about 10:1. This ratio is selected to efficiently reduce the organic contaminant load in the wastewater. For example, the amount of concentrated oxidant solution may be added in a quantity sufficient to lower the contaminant load in the final treated solution to a desired effluent level, e.g. more than a 80% reduction in COD level or preferably more than a 90% reduction in COD.

Since the conductivity of the mixed solution is low, step c) is carried out at lower current density, e.g. 60 mA/cm² to 200 mA/cm². However, it is observed that the majority of the peroxy oxidant species, such as persulfate, are generated in step a), and then after mixing, these oxidant species are quickly and effectively activated on the diamond electrodes in step c), even using the lower current density. As demonstrated by experimental data disclosed herein, this process sequence with electrochemical activation in step c) of the peroxy oxidant species produced in step a) results in much faster and more effective and complete destruction of organic oxidants such as phenol, compared to known processes.

The peroxy oxidant species preferably comprises persulfate or hydrogen peroxide for destruction of organic contaminants comprising one or more of naphthenic acid, phenols, methanol, benzene, isopropyl alcohol, other alcohols, ethers, acrylates, methane, organosulfur compounds, other aromatic hydrocarbons such as Poly-aromatic hydrocarbons (PAHs) and other naturally occurring and added hydrocarbons or other contaminant species subject to oxidation by peroxy compounds, such as those typically found in produced water from hydrocarbon recovery and fracking. However, the method may be unsuccessful in oxidizing some highly oxidation resistant hydrocarbon contaminants, such as synthetic organic pesticides like atrazine and organo-fluorine compounds such as perfluorooctonyl sulfonate.

The oxidative destruction of the organic contaminants may be controlled primarily by the concentration of the concentrated peroxy oxidant solution provided in step a), the original mix ratio in step b), and the current density of the electrochemical destruction step c). While the current density in step c) could be increased without a prohibitive increase in cell voltage by adding salt to increase conductivity and current efficiency, it is desirable to maintain low TDS, even though this limits the electrochemical wastewater treatment step c) to lower current density. Nevertheless, with electrochemical activation in step c) of peroxy oxidant species generated in step a) fast and effective destruction of contaminants was observed. The effectiveness of this process sequence is believed to result from the large store,or concentration of peroxy oxidants that are already available in solution in the initial mixture of wastewater and oxidant, and the relative efficiency of the electrochemical process, at the diamond electrode, for breaking the peroxy bonds to generate reactive and relatively long-lived radical species capable of oxidizing a wide variety of contaminants such as those listed above in paragraph [0021].

In summary, a multistep process sequence is provided for electrochemical treatment of wastewater to destroy organic contaminants. The use of conductive diamond electrodes enables efficient electrochemical generation of concentrated solutions of persulfates or other useful peroxy oxidants in step a). After mixing, during the electrochemical treatment, step c) diamond electrodes effectively activate the peroxy oxidants to provide effective destruction of the organic contaminants. Since the process steps for generation of peroxy species and for electrochemical oxidation and destruction of contaminants are separated, each step of the process can be separately controlled. Thus these steps can be conducted in different cells, and can be conducted separately from the treatment of wastewater with these species under very different electrochemical cell operating conditions, (e.g. cell current density, electrode gap, flow velocity, etc.).

A second aspect of the invention provides a system for treatment of wastewater to destroy organic contaminants, comprising:
a first cell for supplying a concentrated oxidant solution comprising a peroxy oxidant species;
a feed system for mixing wastewater comprising organic contaminants with the concentrated oxidant solution to provide a mixture comprising wastewater and diluted oxidant solution, the wastewater and concentrated oxidant solution being mixed in a prescribed ratio; and
a second cell comprising an electrochemical cell comprising a diamond anode for electrolyzing the mixture of wastewater and diluted oxidant, by electrochemically activating the oxidant species for oxidation and destruction of the contaminants.

Preferably, the first cell comprises a first electrochemical cell comprising a diamond anode for high current density operation for generating a concentrated oxidant solution comprising the peroxy oxidant species, e.g. concentrated persulfate solution.

The first electrochemical cell may be operable for producing a concentrated oxidant solution comprising persulfate at a concentration of about 0.5M, e.g. by electrolysis at high current density from an aqueous solution of ≧1M sulfate, with salt added (0.5 to 2M) to increase conductivity and current efficiency. The first electrochemical cell generates a concentrated oxidant solution at current density in the range from 300 mA/cm² to 1000 mA/cm², or more preferably at 500 mA/cm² to 1000 mA/cm².

The feed system provides for mixing the wastewater and concentrated oxidant solutions in a mole ratio in the range from 5:1 to 25:1, e.g. a mole ratio of about 10:1. This required mole ratio of oxidant to contaminant depends on the electron demand for oxidation of the target organic contaminant species to an environmentally more acceptable, non-toxic species, such as small acids or carbonate.

The second electrochemical cell operates at a lower current density, e.g. from 30 mA/cm² to 200 mA/cm², e.g. 60 mA/cm² for electrolysing the mixture of wastewater and diluted oxidant solution, comprising activating the oxidant species in the wastewater and diluted oxidant solution for rapid and effective destruction of organic contaminants.

Preferred embodiments seek to provide one or more of: an improved rate of contaminant destruction; improved completeness of contaminant destruction for any given type of contaminant; increased range of possible contaminants that can be treated with a given oxidant decreased overall energy costs of the process; decreased the load of salt added to a wastewater in order to treat it; and decreased complexity of the processing.

Thus, a system and method for wastewater treatment are provided, which address at least some of the problems mentioned above.

The foregoing and other objects, features, aspects and advantages of the present invention will become more apparent from the following detailed description, taken in conjunction with the accompanying drawings, of preferred embodiments of the invention, which description is by way of example only.

### BRIEF DESCRIPTION OF DRAWINGS

FIG. 1 illustrates schematically a system for treatment of wastewater using a method according to a first embodiment of the present invention;

FIG. 2 is a graph of experimental results for the method of Example B, showing the concentrations of Napthenic acid and persulfate over time as the persulfate oxidizes the Napthenic acid;

FIG. 3 is a graph of experimental results for Example C, showing of the change in 270 nm UV absorption during a period of 150 minutes of a 100 ppm phenol solution destruction;

FIG. 4 shows experimental results for Example D, in the form of spectrographs during the destruction of Phenol in a 3 liter solution initially containing 24 parts Persulfate to 1 part Phenol using a current density of 300 mA/cm2;

FIG. 5 shows experimental results for Example E, in the form of spectrographs during the destruction of Phenol in a initial 3 liter solution initially containing 10 parts Persulfate to 1 part Phenol using a current density of 300 mA/cm²;

FIG. 6 shows experimental results for Example F, in the form of spectrographs during the destruction of Phenol in a 3 liter solution initially containing 10 parts Persulfate to 1 part Phenol using a current density of 60 mA/cm²;

FIG. 7 shows experimental results for Example G, in the form of spectrographs during the destruction of Phenol in a 3 liter solution initially containing 10 parts Sodium Persulfate to 1 part Phenol using a current density of 100 mA/cm²;

FIG. 8 shows experimental results for Example F, in the form of spectrographs during the destruction of Phenol in a 3 liter solution initially containing 24 parts Sodium Persulfate to 1 part Phenol using a current density of 60 mA/cm²;and

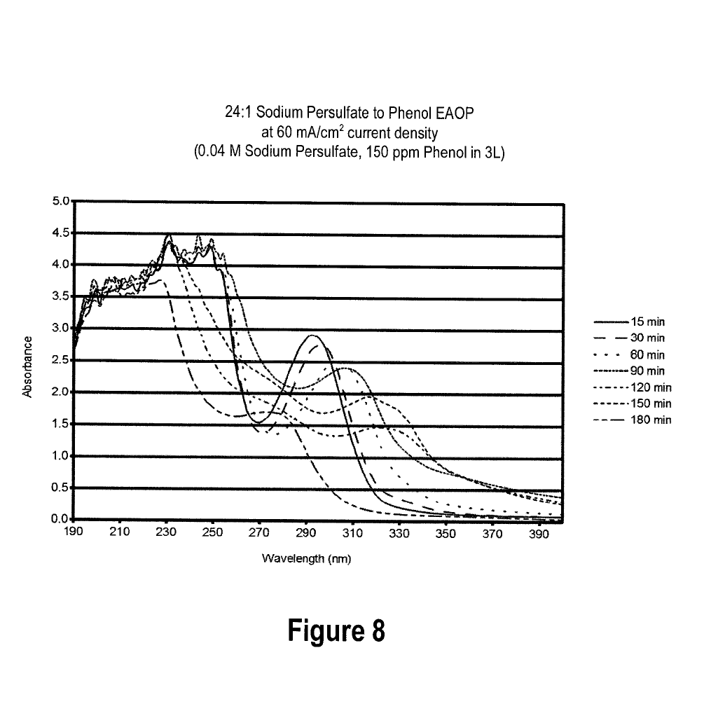

FIG. 9 shows a graph of iodometric results demonstrating the change in of persulfate concentration over time, during the destruction of Phenol in Examples E, F, G and H, relative to a control solution.

FIG. 10 shows a spectrum of the UV absorption region (200-350 nm) of a 3 L, 100 ppm (0.0011M) phenol solution being treated with a 0.036M solution of hydrogen peroxide (H₂O₂) in a Diamonox40 electrochemical cell being operated at 21.2V and 2.5 A (60 mA/cm²) at pH=2 (pH adjusted with 30 ml of 0.25M H₂SO₄, i.e. 0.007M SO₄²⁻) at a mole ratio of 34:1 (H₂O₂:phenol) showing the oxidative destruction of phenol to carboxylic acids over a period of about 2 hours.

FIG. 11 shows a spectrum from a control experiment for the experiment conducted in FIG. 10 in which the phenol was treated directly with a similar concentration of 0.021M solution of H₂O₂ in a beaker with no current applied. This demonstrates that hydrogen peroxide on its own is not capable of oxidizing phenol without a catalyst or the application of the electrochemical cell.

FIG. 12 shows the concentration of oxidant during the experiment shown in FIG. 10 as measured by iodometry (0-2 hours). It is likely that the iodometric determination of the oxidant strength during the experiment is mostly the hydroxyl radical (.OH). The increase in oxidant concentration after approximately the 20 minute mark shows that the some of the hydroxyls are being recreated by the applied current on the diamond anode.

### DETAILED DESCRIPTION OF EMBODIMENTS

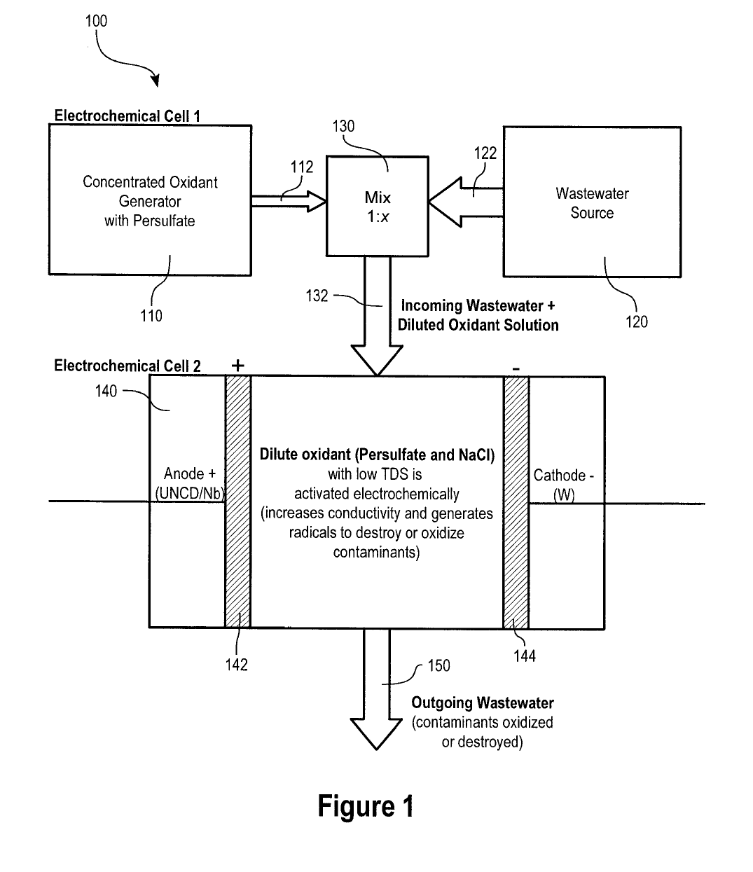

By way of example, a system 100 for treatment of wastewater using a method according to a first embodiment of the present invention is illustrated schematically in FIG. 1. The system comprises a first cell 110 for supplying a concentrated oxidant solution 112 comprising a peroxy oxidant species, such as persulfate; a wastewater source 120 supplying wastewater comprising organic contaminants 122 to be destroyed; and a feed system 130 for mixing the concentrated oxidant solution 112 with the wastewater 122 in a prescribed ratio. The mixture 132 comprising wastewater 122 and diluted oxidant solution 112 is then fed to a second cell 140. The second cell 140 comprises an electrochemical cell comprising at least a diamond anode 142 for electrolyzing the mixture 132, thereby activating the peroxy oxidant species on the diamond anode 142 for oxidation and destruction of the organic contaminants. For example, the anode 142 comprises microcrystalline diamond (MCD) or ultrananocrystalline diamond (UNCD) on a niobium substrate, and the cathode 144 comprises a lower cost tungsten or stainless steel cathode. The cell 140 is operated at a current density in the range from about 20 mA/cm² to 200 mA/cm². The process is continued for sufficient time to oxidize the unwanted organic contaminants in the outgoing wastewater 150 to more environmentally acceptable or non-toxic species, such as small acids or carbonates, for example, and to reduce the concentration of the remaining total organic contaminants to an acceptable level for discharge. As well as providing high reliability, the MCD or UNCD electrodes provide very effective activation of the peroxy oxidant species. Thus, this novel process will be referred to as a diamond activated Electrochemical Advanced Oxidation Process (diamond activated EAOP).

The first cell 110 may supply a pre-prepared, pre-mixed concentrated oxidant solution with a suitable concentration of persulfate, e.g. 0.5M. However, for treatment of large volumes of wastewater, the first cell 110 is preferably also an electrochemical cell for in situ generation of the concentrated oxidant solution electrochemically.

Thus, in a preferred embodiment, wherein the peroxy oxidant species is persulfate (peroxodisulfate), the concentrated solution of persulfate 112 is generated by electrolysis of sulfuric acid, or other aqueous sulfate solution having a concentration of at least 1M, and preferably a more concentrated solution. The solution may contain sufficient salt, i.e. Na₂SO₄, or H₂SO₄ to increase the conductivity of the solution for electrolysis at high current density. The sulfate solution is electrolyzed at high current density, e.g. 300 mA/cm² to 1000 mA/cm² and more preferably in the range from >500 mA/cm² to 900 mA/cm² to generate the peroxy oxidant species with high current efficiency. In alternative embodiments, alternative peroxy oxidant species may be used, such as hydrogen peroxide (H₂O₂), pyrophosphate, perborate or percarbonate, for example, or combinations thereof to achieve different reaction pathways and potentially more complete destruction of contaminants.

The concentrated oxidant solution 112 is generated comprising the persulfate, or other peroxy oxidant species at a concentration that provides a desired dilution or concentration ratio (e.g. a mole ratio) relative to the concentration of a target organic contaminant to be oxidized when the concentrated solution 112 is mixed with the wastewater 122 in the prescribed ratio. For example, produced water from hydrocarbon recovery, which may contain ˜50 ppm, ˜100 ppm or more of organic contaminants, such as phenols, benzene, naphthenic acid, alcohols, organosulfur compounds, hydrogen sulfide, hydrocarbons and other oxidizable contaminants. Thus, if the concentrated oxidant solution comprises, e.g. 0.5M persulfate solution, the treatment, the wastewater 122 and concentrated oxidant solution 112 may be mixed in a 5:1 to 25:1 mole ratio, e.g. 10:1 mole ratio as illustrated schematically in FIG. 1 depending on the concentration of organic contaminants and their composition. If the concentration of organic contaminants is known, the required concentration or dilution ratio of peroxy oxidant can be calculated based on the estimated electron demand for multistep oxidation of a particular contaminant, e.g. phenol or naphthenic acid, to small carboxylic acids or carbonate/CO₂. Thus, the mixture 132 comprises, for example, 20 mM persulfate and 50 ppm phenol before electrolysis in the electrochemical cell 140. In the second electrochemical cell 140, the peroxy oxidant, e.g. persulfate is efficiently activated at the diamond anode 142, i.e. by hydroxyl species on the diamond surface. Even when operated at relatively low current density, oxidation of the organic contaminants such as phenols and naphthenic acid or other refractory or toxic contaminant is demonstrated to proceed with high current efficiency, and much more rapidly than simply mixing the concentrated oxidant solution 112 with the wastewater 122 without electrochemical treatment in the second cell 140, as illustrated by the following Examples.

### EXAMPLES

Examples will now be described to illustrate the application of methods according to embodiments of the invention, i.e. diamond activated EAOP processes, for destruction of refractory organics including, for example: methanol, phenol, estradiol, methylene blue and napthenic acids, in an electrochemical system comprising ultrananocrystalline diamond (UNCD) electrodes for diamond activation of peroxy oxidant species.

### Example A

### Destruction of Methylene Blue

Table I shows non-optimized diamond activated EAOP experiments with input persulfate (PS) and solar salt concentrations, cell operating conditions and calculated rates, current efficiencies and calculated operating (OPEX) and capital costs (CAPEX) for oxidative destruction of methylene blue (MB).

TABLE 1
Experimental UNCD electrode activated Waste Remediation (Methylene Blue) results

| | | | | | | | | | CAPEX at | |
|---|---|---|---|---|---|---|---|---|---|---|
| | | | | | | | | | diamond price | |
| | | | | | Current | Rate of | Energy | OPEX = | of $60,000/m² | |
| Solar | | | | | Efficiency | destruction | cost at | Energy + | and electrode | CAPEX + |
| Salt | PS | | Cell | Current | assuming | (tonnes | 7 ¢/kWh | salt + PS | life-time = | OPEX |
| mostly | S₂O₈²⁻ | Solution | Voltage | Density | 4e-/mole | waste/day-m² | ($/tonne | ($/tonne | 5 years | ($/tonne |
| NaCl (M) | (M) | Volume (L) | (V) | (mA/cm²) | MB (%) | of electrode) | waste) | waste) | ($/tonne waste) | waste) |
| 0.5 | 0.01 | 0.2 | 8.1 | 300 | 1.1% | 11.4 | $357.21 | $360.87 | $3.00 | $360.87 |
| 0.5 | 0.01 | 0.2 | 6.4 | 150 | 1.8% | 9.8 | $164.64 | $168.30 | $3.50 | $171.80 |
| 0.5 | 0.01 | 0.2 | 4.2 | 30 | 4.3% | 4.6 | $45.75 | $49.41 | $7.50 | $56.91 |
| 0.5 | 0.01 | 0.2 | 3.8 | 10 | 27.3% | 9.8 | $6.43 | $10.09 | $3.50 | $13.59 |
| 0.1 | 0.01 | 0.2 | 15.5 | 300 | 0.9% | 9.8 | $797.48 | $800.21 | $3.50 | $803.71 |
| 0.1 | 0.01 | 0.2 | 9.8 | 150 | 1.2% | 6.2 | $396.17 | $398.90 | $5.50 | $404.40 |
| 0.1 | 0.01 | 0.2 | 5.8 | 30 | 2.6% | 2.7 | $106.58 | $109.31 | $12.50 | $121.81 |
| 0.1 | 0.01 | 0.2 | 4 | 10 | 27.3% | 9.8 | $6.86 | $9.59 | $3.50 | $13.09 |
| 0.1 | 0.01 | 1 | 4.2 | 10 | 16.0% | 5.7 | $12.26 | $14.99 | $6.00 | $20.99 |
| 0.1 | 0.01 | 1 | 3.9 | 5 | 13.7% | 2.5 | $13.34 | $16.07 | $14.00 | $30.07 |
| 0.1 | 0 | 1 | 5.4 | 30 | 4.3% | 4.6 | $59.54 | $59.77 | $7.50 | $67.27 |
| 0 | 0.05 | 1 | 4.6 | 30 | 1.0% | 1.1 | $213.00 | $225.14 | $31.50 | $256.64 |
| 0.1 | 0.05 | 1 | 4.8 | 30 | 5.4% | 5.8 | $41.63 | $53.76 | $5.90 | $59.66 |
| 0.01* | 0 | 0.2 | 13.1 | 30 | 1.6% | 1.7 | $385.14 | $385.16 | $20.00 | $405.16 |

The oxidative destruction of methylene blue was monitored by changes in the absorbance of its 665 nm visible light absorption peak by spectrophotometry. Table 1 shows the results of various experiments for a range of concentrations of added solar salt (SS, which substantially comprises sodium chloride, NaCl), and persulfate (PS) (peroxodisulphate), concentrations at different applied cell current densities. Methylene blue destruction rates by persulfate at ambient temperature outside an electrochemical cell (i.e. not activated by the electrochemistry within the cell), without a catalyst, are at least 3 orders of magnitude slower, while solar salt does not oxidize methylene blue at all. Referring to table 1, lower current densities generally show higher current efficiency but lower destruction rates. However, the rate, current efficiency and energy costs are significantly improved by higher concentrations of solar salt added to the solution, by lower current densities and by higher concentrations of added persulfate, in that order. Given that the rate is being measured by changes in a visible absorption peak, the Cl (solar salt) concentration is likely to show a disproportionately large effect since Cl. (chlorine radicals) generated on a UNCD anode are sufficiently reactive to break the single-bonds between conjugated pi-bond absorbers in methylene blue and to separate the molecule into non-UV/Vis absorbing fragments. Other experiments conducted with sodium fluoride have demonstrated increases in oxidative destruction rates as well at a similar rate to the increase from chloride and persulfate. This suggests the possibility that fluorine radicals are being created on the doped diamond surface and are themselves agents for oxidation of the organic contaminants.

The 95% level of destruction of methylene blue was monitored by the decline in the absorbance of the 665 nm visible absorption peak of methylene blue by spectrophotometer. Reasonable assumptions for cost calculations are as listed above, e.g. a commercial electricity price of 70 per kWh, a high volume diamond price of $60,000/m² and commercial prices of $1.00/kg for purchased persulfate and $0.04/kg for solar salt. The rows indicate candidate conditions that produced both reasonable rates of methylene blue destruction at reasonable OPEX and CAPEX with reasonable trade-offs for salt concentration and rate of destruction. Higher persulfate concentrations than were used in these experiments would have reduced the OPEX/CAPEX further. Note that the bottom entry (*) in the table showing a very low solar salt concentration (0.01M=580 mg/L, 580 ppm) with a low destruction rate and high OPEX/CAPEX, would be representative of an “as-extracted” salt concentration of a wastewater without added salt. Very low cost persulfate can be synthesized on UNCD from the oxidation of sodium sulfate or sulfuric acid (see next section) which would greatly improve current efficiency and lower OPEX and CAPEX. OPEX and CAPEX close to $1/tonne are likely with further process optimization for this type of relatively non-refractory organic

### Example B

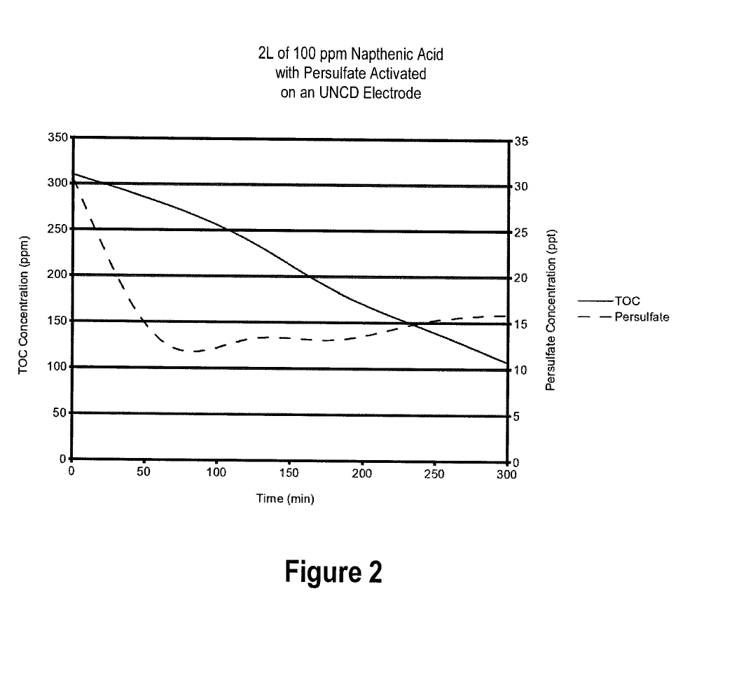

Destruction of Napthenic Acid. In this example, experimental results are provided for oxidation and destruction of phenol and napthenic acid by electrochemically activated persulfate solutions. These results show the rate of destruction of the organic contaminant with time, as evidenced by spectrophotometry, together with the electrochemical regeneration of persulfate as oxidation of the organic contaminant proceeds towards completion (e.g. see FIG. 2). It is evident from the results presented below that, in this multistep process, the majority of the persulfate oxidant species are present in the mixture 132 of wastewater and diluted oxidant that enters the electrochemical cell 140, and subsequently these persulfate species are activated by the diamond electrode 142 to effect oxidation and destruction of the organic contaminants more rapidly and efficiently than other known processes. It is believed that, because a suitable concentration of persulfate or other peroxy oxidant species are supplied to the electrochemical cell 140 in the mixture 132, the oxidant species do not need to be electrochemically generated in situ, and instead the electrical energy supplied to the electrochemical cell 140 is therefore used more effectively for activating the available persulfate or other peroxy oxidant species in the mixture 132.

FIG. 2 shows persulfate concentrations upon activation on an UNCD anode and Total Organic Carbon (TOC) vs. time for a 2 L, 100 ppm napthenic acid solution with 250 ppm of methanol in an ADT Diamonox 40 cell (42 cm² active cell area) operated at 300 mA/cm²(12.6 A and 3.6V) for 5 hours.

Prior to the addition of the napthenic acid and methanol, 2 L of a 0.64M persulfate solution, (i.e. .SO₄⁻ concentration=30,500 mg/L, shown at time=0 minutes on the graph) was generated from 4M sulfuric acid in the same cell operated at 600 mA/cm² (25.2 A and 4.1V) for 2.75 hours with a current efficiency of 49%.

The dashed line shows the concentration of monoperoxosulfate ion (.SO₄⁻) (“persulfate”) as measured by iodometry. A UV spectrometer was also used to assess the formation of oxidative breakdown products of napthenic acid. The UV spectrum showed that a large concentration of acetic acid or other carboxylic acid species was present after the first hour. After the initial drop in persulfate concentration in the first hour, the UNCD anode recreates the persulfate from non-oxidized sulfate (SO₄²⁻) already in the solution, producing additional current efficiency and offering the possibility of reuse of the sulfate solution.

The solid line shows the total organic carbon in ppm. This is the total oxidative conversion of all the organic carbon present to carbonate ions (CO₃²⁻) and CO₂. It also shows a 30-35% current efficiency destruction of the napthenic acids and methanol.

This proof-of-concept experiment on a synthetic fracking waste comprising a two-component solution of methanol (MeOH) and napthenic acid (NA) was conducted to demonstrate the potential for this activated EAOP technology. Initially, a 2 L 0.64M persulfate (PS) solution was generated by the oxidation of 4M sulfuric acid in an electrochemical cell with a UNCD anode. Subsequently, a 2 L solution of 250 ppm MeOH and 100 ppm laboratory-grade NA was added to the prepared persulfate solution to form a combined volume of 4 L. The experimental parameters and results from the subsequent NA/MeOH oxidation with persulfate in the same cell are shown in FIG. 1. The solid line shows the Total Organic Carbon (TOC) concentration of the NA/MeOH mixture vs. time and a ˜70% total organic carbon decline in 300 minutes. The dashed line shows the oxidant concentration in the form of the monoperoxosulfate radical (.SO₄⁻) with diamond shaped indicators vs. time as measured by iodometry. The rapid decline in .SO₄⁻ concentration in the 1^{st} hour, corresponds to the initial destruction of large, high molecular weight (MW), less refractory NA molecules. After the 1^{st} hour, the remaining organic carbon in the solution has largely been converted to smaller, lower MW, more refractory acids such as acetic or oxalic acid as evidenced by a broad UV absorbance below 300 nm in the UV-Vis spectrum (not shown). After the 1^{st} hour, in addition to the continuation of the 30-35% current efficiency for total organic carbon reduction of NA/MeOH, the concentration of (.SO₄⁻) radicals increases as sulfate ions (SO₄²⁻) in the solution are oxidized back to .SO₄⁻ on UNCD thus capturing additional current efficiency. In addition to rapid NA destruction and conductivity increases facilitated by persulfate, i.e. lower OPEX, persulfate and sulfate ions also protect UNCD and lengthen electrode lifetime (lower CAPEX) from acetic acid catalyzed oxidation since electrons that would otherwise oxidize the diamond electrode and reduce its life instead are used to increase persulfate concentration and thereby greatly reduce the overall operating costs of the process. The calculated energy cost for this non-optimized remediation experiment was ˜40 kWh/tonne of NA (100 ppm)/MeOH (250 ppm), or $2.80/tonne at 7¢/kWh. The increase in persulfate concentrations during this experiment shows that less expensive Na₂SO₄ feedstock in the place of persulfate would be suitable for the destruction of even refractory organics (such as phenol and other aromatics) in fracking waste, although it would necessitate a higher amount of added salt (an increase in Total Dissolved Solids-TDS), a higher applied current density and a longer reaction time than can be achieved by the diamond activated EAOP process.

A two-step process in which a highly concentrated oxidant solution is first prepared and then diluted to form an initial oxidant to contaminant ratio which is then activated on a diamond anode reduces the TDS level and allows the use of low current density and lower voltages appropriate for a dilute contaminant mixture which is referred to as a “Diamond Activated Electrochemical Advanced Oxidation Process” (DAEAOP). A combined CAPEX/OPEX of <$1-$2 per tonne ($0.16-$0.32/bbl) should be achievable with an appropriate selection of salt concentrations, current density and flow rates. This compares very favorably with typical fracking waste trucking costs of $18/tonne ($3/bbl¹) and overall fracking waste treatment costs of $30/tonne ($5/bbl).

### Example C

### Destruction of Phenol

Further diamond activated EAOP experiments were implemented with phenols, which are one of the key refractory containments found in the waste water of oil recovery processes such as “fracking” or bitumen recovery, other enhanced oil recovery (EOR) processes or in oil refinery wastes.

Table 2 shows the results of the decomposition of a 100 ppm concentration of Phenol (molecular weight=94.1 g/mol) using 200 ml solutions of Persulfate, sodium fluoride (NaF), and Solar Salt (SS), comprised mostly of mostly of NaCl.

TABLE 2
Experimental UNCD electrode activated Waste Remediation (Phenol) results

| | | | | | | | OPEX PER |
|---|---|---|---|---|---|---|---|
| Phenol | Current | | | | Time to De- | | TONNE of |
| Concentration | Density | Salt Type and | Persulfate | Average | stroy >95% | Current | 100 ppm |
| (ppm) | (mA/cm²) | Concentration | Concentration | Voltage | (minutes) | Efficiency | Phenol |
| 100 | 100 | 0 | 0.05M | 7.6 V | 45 | 3.00% | $7.85 |
| 100 | 30 | 0 | 0.05M | 4.5 V | 150 | 3.00% | $7.07 |
| 100 | 30 | 0.05M SS | 0 | 6.2 V | 20 | 22.50% | $0.35 |
| 100 | 30 | 0.05M SS | 0.05M | 4.9 V | 20 | 22.50% | $6.25 |
| 100 | 30 | 0.05M NaF | 0 | 7.5 V | 80 | 12.00% | |
| 100 | 30 | 0 | 0.2M | 10.6 V | 45 | 9.00% | $24.68 |

In the experiments with persulfate, the persulfate was generated by electrolyzing a 0.11 M concentration from 0.5 M anhydrous sodium sulfate (Na₂SO₄).

In table 2, the operating expense (OPEX) per tonne to decompose 100 ppm Phenol is determined assuming 70/kWh for the electricity for the electrolysis. In the experiments with solar salt, a further expense of 2¢/lb for the salt based on current industrial bulk prices for this very impure feedstock. With the persulfate being produced from sodium sulfate, the anhydrous sodium sulfate was estimated at 5¢/lb at current industrial bulk prices. The cost of electrical power (at 7¢/kWh) for UNCD synthesis of persulfate was included resulting at a cost of 56¢/kWh or 11.9¢/mole of persulfate. The cost of the sodium fluoride at the bulk prices was not obtainable but would be substantially higher than solar salt or persulfate costs.

From these experiments, solar salt is a very effective agent for the destruction of phenols although the production of chlorinated organic byproducts such as chloroform or trichloroacetic acid are possible using these chemistries. Using UNCD electrodes for the anode a 30 mA/cm² current density provides a better than 95% decomposition or destruction of the phenols in 20 minutes with a current efficiency of 22.5%. This configuration also provides a substantially low OPEX per tonne of 100 ppm phenol of only $0.35. Higher current densities tend to increase the overall rate of destruction and therefore to reduce the capital cost of the electrodes required. However, higher current densities also tend to exhibit lower current efficiencies and therefore the operating costs tend to be higher. The overall efficiency of the persulfate only oxidation is greatly increased and the cost to destroy reduced when the persulfate is generated from sulfuric acid (see examples below).

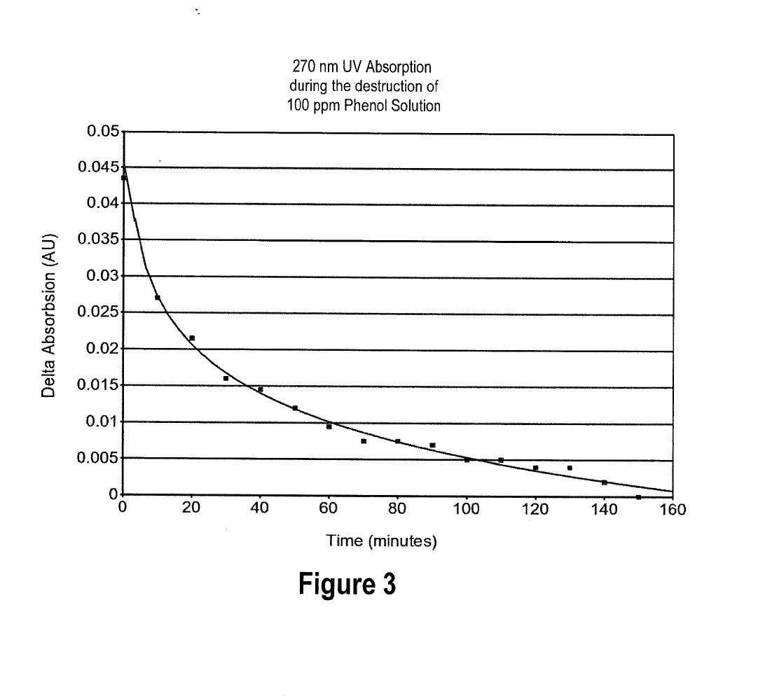

Table 3 and FIG. 3 demonstrate the rate of destruction over time of phenol using a 200 ml solution of 100 ppm phenol with 0.05 M sodium persulfate at a current density of only 30 mA/cm2 showing the activated destruction of the phenol with persulfate (PS). The mole ratio of this experiment was about 25:1 PS:phenol. The 270 nm UV absorption line was measured at 10× dilution using arbitrary absorption units (AU).

TABLE 3
Rate of decomposition of 100 ppm phenol using
0.05M of Sodium Persulfate

| Time | Voltage | | Absorption (Direct | Delta Absorption |
|---|---|---|---|---|
| (min.) | (v) | I (mA/cm²) | reading) AU | (AU) |
| 0 | 5.24 | 30 | 0.207 | 0.0435 |
| 10 | 5.08 | 30 | 0.177 | 0.027 |
| 20 | 5.07 | 30 | 0.158 | 0.0215 |
| 30 | 5.05 | 30 | 0.143 | 0.016 |
| 40 | 5.02 | 30 | 0.137 | 0.0145 |
| 50 | 5 | 30 | 0.129 | 0.012 |
| 60 | 4.9 | 30 | 0.112 | 0.0095 |
| 70 | 4.9 | 30 | 0.098 | 0.0075 |
| 80 | 4.9 | 30 | 0.097 | 0.0075 |
| 90 | 4.9 | 30 | 0.092 | 0.007 |
| 100 | 4.8 | 30 | 0.083 | 0.005 |
| 110 | 4.4 | 30 | 0.084 | 0.005 |
| 120 | 4.3 | 30 | 0.075 | 0.004 |
| 130 | 4.29 | 30 | 0.067 | 0.004 |
| 140 | 4.2 | 30 | 0.065 | 0.002 |
| 150 | 4.2 | 30 | 0.06 | 0 |

### Example D

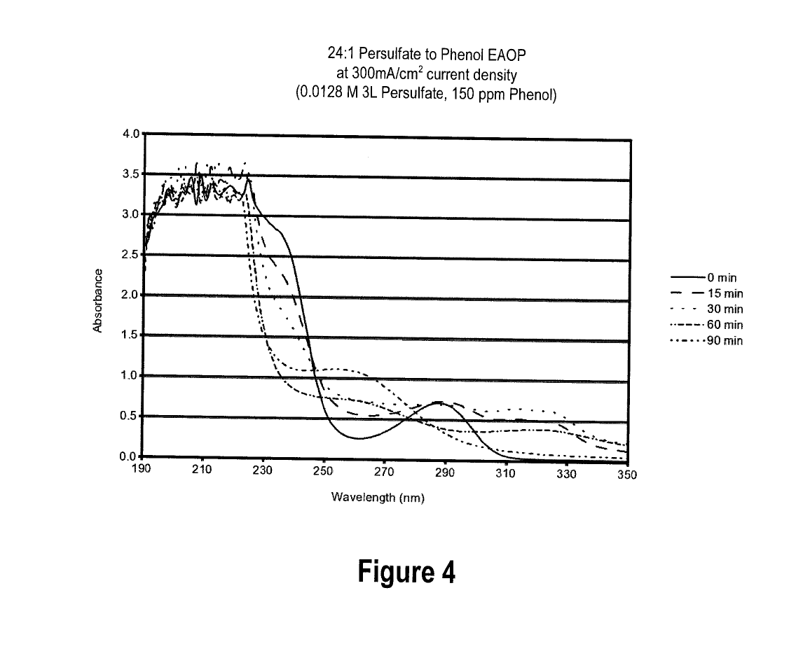

FIG. 4 shows the spectrographs of a further experiment on destruction of phenol. Persulfate was synthesized in a cell from 2.0M sulfuric acid using UNCD electrodes at a current density of 300 mA/cm². The production of persulfate with this method is very efficient as known in the art. The persulfate concentration for the activated treatment of contaminants was begun at a concentration of 0.0128 M in a 3 L volume. Phenol was then added to the persulfate concentration to produce 150 ppm or a mole (concentration) ratio of the starting persulfate concentration to phenol of 24:1. The cell continued operation at 300 mA/cm². This current density provided activation of the persulfate to more completely destroy the phenol.

The shorter time spectra in FIG. 4 shows the initial creation of hydroquinone indicated by the dual stronger peaks at 240 nm and 290 nm (0 and 15 minutes). Time progression shows the destruction of the hydroquinone and the creation of organic acids as indicated by the broad frequency range starting at about 330 nm and growing stronger at shorter wavelengths (shown in the 30 minute sample). The organic acids are then destroyed at the longer time samples where the higher wavelengths diminish to close to zero (60 and 90 minutes).

### Example E

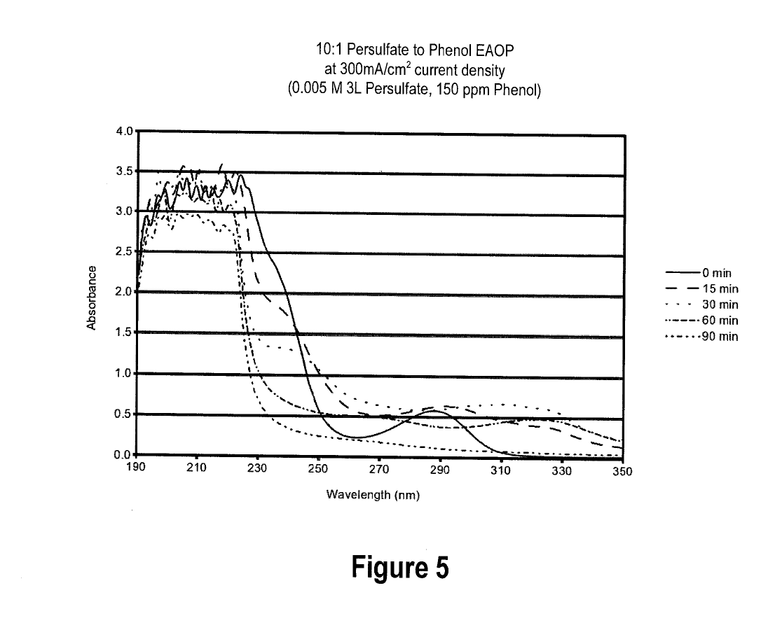

FIG. 5 shows a similar experiment to that shown in FIG. 4. However, the mole ration of persulfate to phenol was reduced to 10:1. A lower persulfate concentration of 0.005 M in a 3 L volume was used. Again, the persulfate was initially produced by reacting 2.0M sulfuric acid in an electrochemical cell using UNCD electrodes before mixing with phenol at a 10:1 mole ratio at a current density of 600 mA/cm². The activated experiment was then conducted at a current density of 300 mA/cm². Even at this lower concentration of persulfate, hydroquinone is produced (the stronger peaks at 240 nm and 290 nm) and then destroyed while the organic acids are created. The organic acids are then substantially destroyed by 90 minutes even with the lower 10:1 mole ratio persulfate concentration.

### Example F

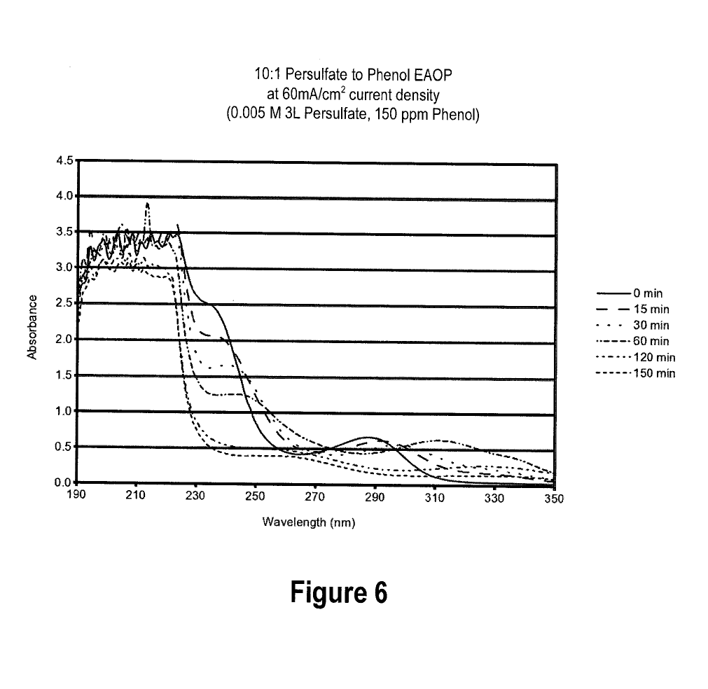

A further experiment is shown in FIG. 6 where the persulfate is produced at a normal level of 600 mA/cm² in an electrochemical cell with UNCD electrodes. However, when the phenol is mixed in, the current density is reduced to 60 mA/cm² for the activation stage of the persulfate reaction with the phenol contaminant.

### Example G

In another example, the oxidant (persulfate) in solid form, sodium persulfate, (Na₂S₂O₈) was added at a ratio of ten parts sodium persulfate to one part phenol directly to the wastewater instead of being synthesized in a first cell. The experimental results show that electrochemical activation of the peroxy oxidant species in a wastewater mixture comprising a minimum amount of oxidant and accompanying salt can provide a similar level of activation compared to that achieved with all the extra salinity (TDS) of a “standard EAOP” (Electrochemical Advanced Oxidation Process) which is usually done with the whole process being conducted as a combined synthesis/oxidation process. By performing the process sequence disclosed herein, the amount of added persulfate and non-oxidized sulfate salt can be reduced which reduces the overall TDS increase in the wastewater solution from the addition of the oxidant mixture, the oxidation process is speeded up and the amount of power required is significantly reduced.

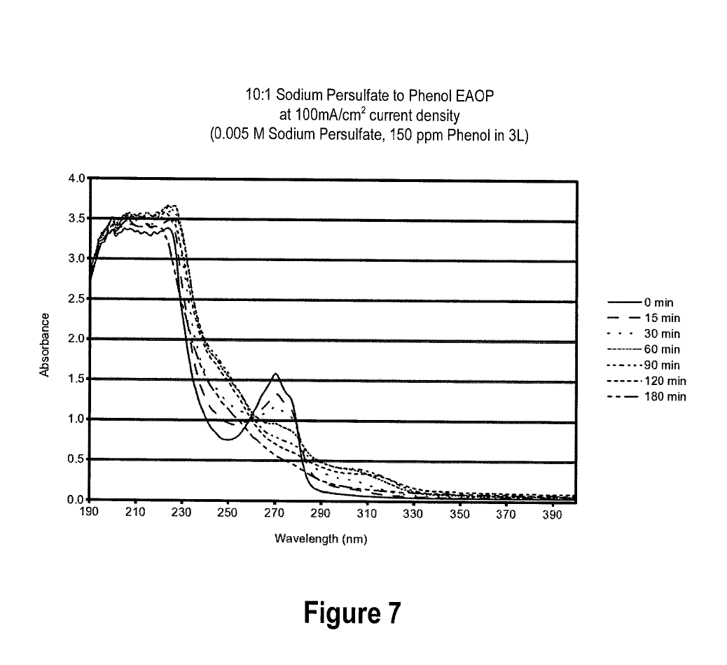

The graph in FIG. 7 shows the UV spectrum of the aromatic region and the characteristic phenol absorption at around 270 nm which disappears as the phenol is oxidized. This oxidation is performed at about pH8 which is different from the pH ˜1.0 of the previous persulfate experiments. The difference in reaction pathway shows up in that hydroquinone (C₆H₆O₂), HQ, (broad peak around 290-300 nm) does not appear. It is presumed that the alkaline pH prevents the substitutional oxidation to HQ and instead produces reactions which directly break the aromatic ring and produce small molecule acids (oxalic, C₂H₂O₄ and acetic, C₂H₄O₂) in which have absorption peaks around 220 nm and do not have UV absorption in the 240-300 nm “aromatic region” (like phenol and hydroquinone).

### Example H

In a further example, similar to example G, sodium persulfate solid was added directly to the wastewater at a mole ratio of sodium persulfate to phenol of twenty-four to one. The persulfate concentration declined during the experiment with the lower current density of 60 mA/cm² but the effectiveness of the destruction is very high (i.e. the persulfate is being “activated” by the electrode and the even the relatively current density of 60 mA/cm²). The final spectrum at 3 hours shows the organics (absorption around 320-350 nm) greatly reduced in concentration if not completely absent. The pH was reduced to 1.6 and 30 mM of extra sulfate was added to reduce the cell voltage. The total concentration of added sulfate is therefore 30 mM, added as sulfuric acid, and 40 mM×2 added from the persulfate (persulfate has 2 moles of sulfate), for a total of 110 mM (0.11M) of net sulfate in the final solution. That is about 10 g/L of sulfate overall, or 10,000 ppm.

Iodometric Results

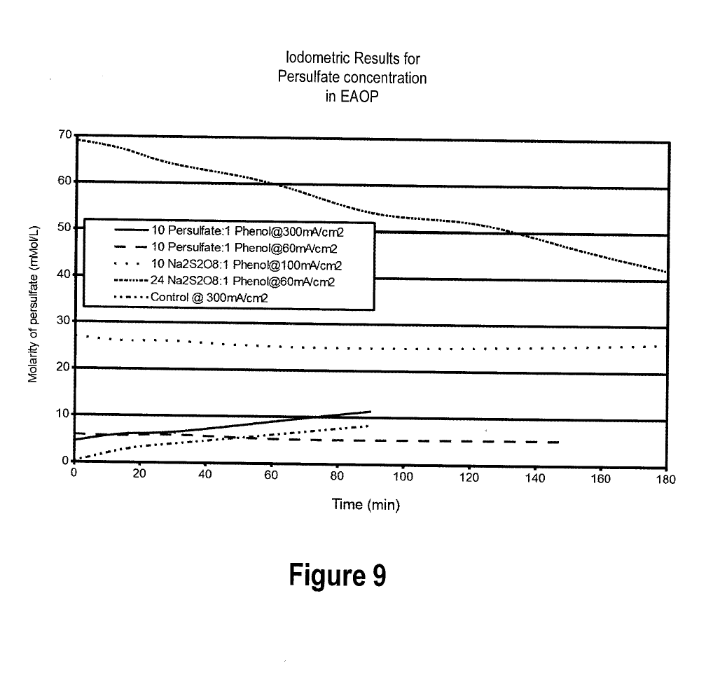

FIG. 9 shows the persulfate concentration over the duration of the experiments described in Examples E, F, G, and H with the independent variable (x-axis) as time and the concentration of persulfate as the dependent variable (y-axis). A control experiment was also used in this comparison to show the persulfate concentration without an applied current.

### Example I

### Diamond Activated EAOP with Hydrogen Peroxide

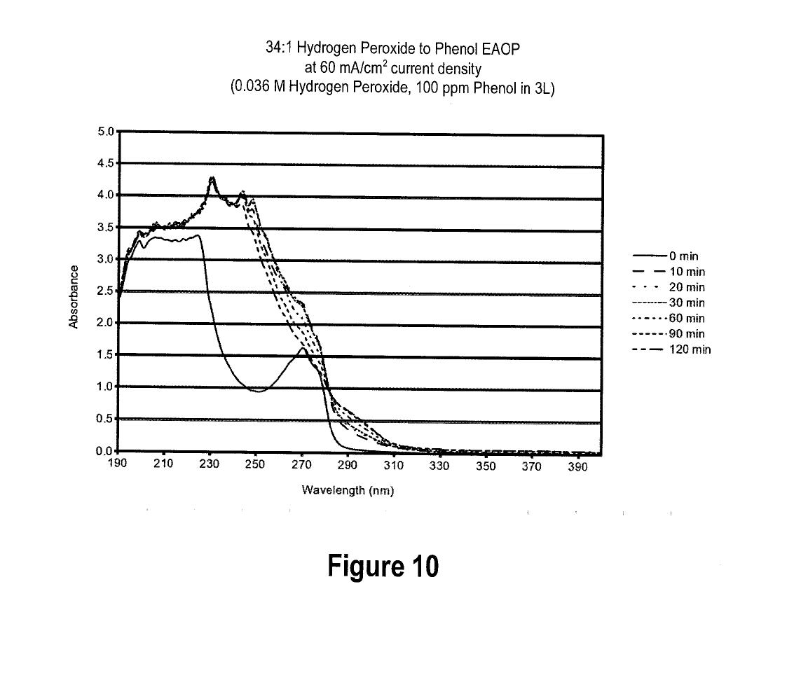

In a further example of the method using hydrogen peroxide as the principal oxidizing species, FIG. 10 shows a DAEAOP experiment with a 3 L, 100 ppm (0.0011M) phenol solution destroyed by a 0.036M H₂O₂ solution as measured by iodometry with the hydroxyl radical as the likely oxidant species, i.e. the net concentration of H₂O₂ was actually 0.018M. The mole ratio of hydroxyl radical oxidant to phenol was therefore 34:1. The solution was acidified to pH=2 with a small concentration of sulphuric acid (0.007M SO₄²⁻). FIG. 10 shows that the majority of the phenol is destroyed by the 10-20 minute mark as evidenced by the change in UV absorption of the principal phenol absorption peak at 270 nm. The formation of organic acids with a broad absorption from ˜220 nm to ˜300 nm is evidence for the breakdown of the aromatic ring. The application of current at 53 W and 0.054 moles of H₂O₂ was used to destroy the 100 ppm of phenol in 3 L of solution. At an assumed electricity cost of 7¢/kWh this works out to a power cost of 4.5¢/tonne of 100 ppm phenol waste and at an assumed bulk peroxide price of $1000/tonne for 35% peroxide ($0.10/mole), this works out to a peroxide cost of $1.80/tonne of 100 ppm phenol waste. The cost of peroxide dominates the cost of phenol treatment. However, this feedstock cost could be reduced further by increasing the current density with a slight increase in the cost of power and increasing the amount of sulphuric acid present which would both decrease the cost of power (lower voltage) and also increase the rate of oxidation. This would greatly reduce the amount of peroxide required and the feedstock cost but would also slightly increase the amount of salt (i.e. increased TDS) in the form of sulfate ion added to the solution.

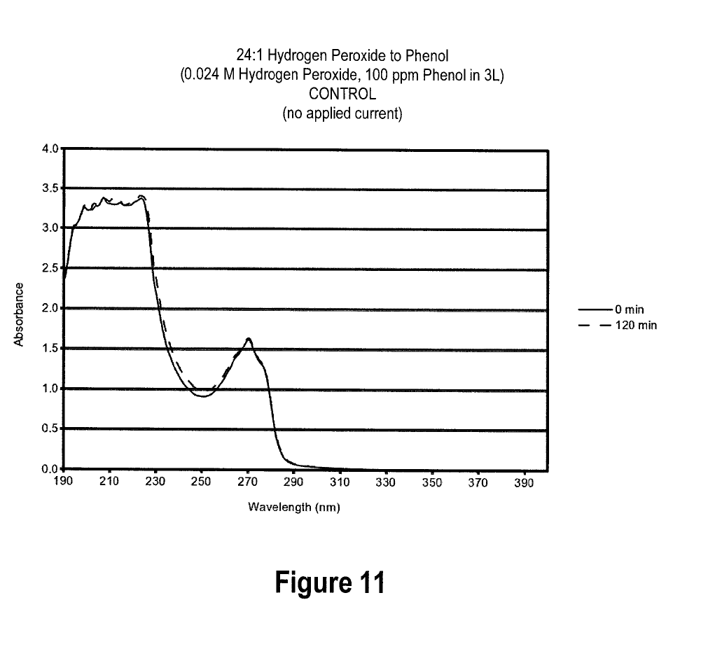

FIG. 11 shows the control experiment for the peroxide plus phenol experiment shown in FIG. 10. The control experiment shown in FIG. 11 shows a similar concentration ratio of hydrogen peroxide to phenol to that used in FIG. 10, i.e. 24:1 simply added to the phenol solution outside of an electrochemical cell without activation by current or any other means. After 2 hours the phenol spectrum is essentially unchanged which is consistent with the known lack of reactivity of hydrogen peroxide with phenol.

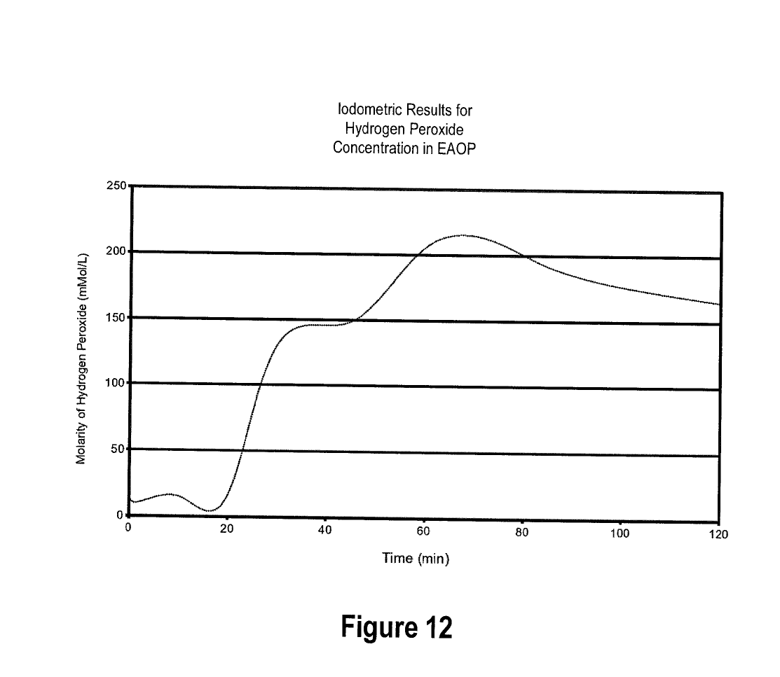

FIG. 12 shows the relative oxidant concentration in mM (millimolar) as measured by iodometry for the experiment conducted in FIG. 10. The initial destruction of phenol in the first 20 minutes of the experiment is accompanied by a plateau or a slight decline in the measured oxidant concentration. Once the aromatic phenol is destroyed and the organic acids are formed, the oxidant concentration increases. This may be due to recreation of the hydrogen peroxide from the anodic current on the diamond.

### SUMMARY

Exemplary experiments have been described to demonstrate the effectiveness of the method of treating wastewater containing organic contaminants in a laboratory setting. While mixtures of wastewater and oxidant are described comprising specific mole ratios of organic contaminants and peroxy oxidants, it will be apparent that in large scale processing, the initial concentration and organic contaminant species may be uncertain or unknown, or vary from process to process or from day to day. Consequently, the prescribed ratio for mixing the concentrated oxidant solution with the wastewater would typically be determined empirically for a particular wastewater application.

For example, it may be sufficient that the wastewater is treated only to reduce its COD (chemical oxygen demand) below a certain threshold, or reduce total organic contaminants or specific organic contaminants to an acceptable level, rather than to completely destroy the contaminants. Thus the prescribed ratio for dilution of the concentrated oxidant solution may simply be estimated to provide a sufficient concentration of peroxy oxidant species for effectively meeting the required threshold or target parameter for wastewater treatment. In other applications, where the composition or concentration of contaminants is known, and a particular level of destruction is required, the prescribed ratio may be more specifically determined to provide a suitable concentration ratio or mole ratio of oxidant to organic contaminant to effect a required level of destruction of the organic contaminant within a given time frame, for example, typical initial persulfate (or alternative peroxy oxidant) concentrations would be in the range of 0.1M to 2.0M with an initial mole ratio of the peroxy species to contaminant of at least 5:1 or as much as 25:1 where the peroxy species is persulfate and the contaminant species is phenol with a molecular weight of 94 g/mole. For the example of larger molecular weight contaminants, such as napthenic acids (which often have molecular weights in the range from 200-300), higher mole ratios of persulfate oxidant are appropriate because of the larger number of carbon and hydrogen atoms that require oxidation. In general, the above-mentioned 5:1 to 25:1 mole ratios for persulfate and phenol can be translated into a similar mass ratio of persulfate oxidant to contaminant (i.e. a mass ratio between 5:1 and 25:1). Other peroxy species will preferably utilize mass ratios proportional to the difference in their molecular weights as compared to persulfate. For example, the use of hydrogen peroxide (H₂O₂) with a molecular weight of 34 g/mole as compared to the molecular weight of persulfate of 238 g/mole, would imply a mass ratio of between 0.7 to 3.6 instead of 5:1 to 25:1 for persulfate. For other peroxy oxidant species, the concentration ratio of oxidant to contaminants for diamond activated EAOP will need to be adjusted accordingly, keeping in mind the respective molecular weights of the selected peroxy oxidant and the contaminants to be destroyed.

Although embodiments of the invention have been described and illustrated in detail, it is to be clearly understood that the same is by way of illustration and example only and not to be taken by way of limitation, the scope of the present invention being limited only by the appended claims.

1. A method for treatment of wastewater to destroy organic contaminants, comprising:
a) generating a concentrated oxidant solution comprising a peroxy oxidant species;
b) mixing wastewater comprising organic contaminants with the concentrated oxidant solution to provide a mixture comprising wastewater and diluted oxidant solution, the wastewater and concentrated oxidant solution being mixed in a prescribed ratio; and
c) in an electrochemical cell comprising a diamond anode, electrolyzing the mixture of wastewater and diluted oxidant solution, comprising electrochemically activating the oxidant species on the diamond anode for oxidation and destruction of the contaminants.

2. The method of claim 1 wherein the peroxy oxidant species comprises persulfate and/or hydrogen peroxide.

3. The method of claim 1 wherein the peroxy oxidant species comprises one or more of persulfate, hydrogen peroxide, pyrophospate, percarbonate, or perborate or mixtures thereof.

4. The method of claim 2 wherein the concentrated oxidant solution comprises a peroxy oxidant species at a concentration that provides a desired dilution ratio relative to the concentration of a target organic contaminant to be oxidized.

5. The method of claim 1 where step a) comprises generating the concentrated oxidant solution by electrolysis at high current density in an electrochemical cell comprising a diamond anode, from an aqueous solution containing greater than a 1M concentration of sulfate.

6. The method of claim 4 wherein the current density for step a) is in the range from 300 mA/cm² to 1000 mA/cm².

7. The method of claim 4 wherein the current density for step a) is in the range from 500 mA/cm² to 900 mA/cm².

8. The method of claim 1 wherein the wastewater and concentrated oxidant solution are mixed in a mass ratio of oxidant to contaminant in the range from 5:1 to 25:1.

9. The method of claim 1 wherein the wastewater and concentrated oxidant solution are mixed in a mass ratio of oxidant to contaminant of about 10:1.

10. The method of claim 1 wherein the wastewater and concentrated oxidant solution are mixed in a prescribed ratio to provide a desired concentration ratio of oxidant species to organic contaminants.

11. The method of claim 1 wherein the peroxy oxidant species comprises persulfate and/or hydrogen peroxide and the organic contaminants comprise one or more of naphthenic acids, phenols, methanol, benzene, alcohols, aromatic compounds, ethers, carboxylic acids, organosulfur compounds or hydrogen sulfide.

12. A system for treatment of wastewater to destroy organic contaminants, comprising:
a first cell for supplying a concentrated oxidant solution comprising a peroxy oxidant species;
a feed system for mixing wastewater comprising organic contaminants with the concentrated oxidant solution to provide a mixture comprising wastewater and diluted oxidant solution, the wastewater and concentrated oxidant solution being mixed in a prescribed ratio to provide a desired concentration ratio of oxidant species to organic contaminants; and
a second cell comprising an electrochemical cell comprising a diamond anode for electrolyzing the mixture of wastewater and diluted oxidant, by electrochemically activating the oxidant species on the diamond anode for oxidation and destruction of the contaminants.

13. The system of claim 12 wherein the first cell comprises an electrochemical cell comprising a diamond anode for high current density operation for generating a concentrated oxidant solution comprising the peroxy oxidant species.

14. The system of claim 12 wherein the first cell comprises an electrochemical cell comprising a diamond anode for high current density operation for generating a concentrated oxidant solution comprising persulfate.

15. The system of claim 14 wherein the first electrochemical cell is operable for producing a concentrated oxidant solution comprising persulfate in a concentration range from about 0.5M to 2.0M.

16. The system of claim 12 wherein the first electrochemical cell generates a concentrated oxidant solution comprising peroxy species by electrolysis at high current density from an aqueous solution of ≧1M sulfate, with salt added to increase conductivity and current efficiency.

17. The system of claim 16 wherein the first electrochemical cell generates a concentrated oxidant solution at current density in the range from 300 mA/cm² to 1000 mA/cm².

18. The system of claim 12 wherein the feed system provides for mixing the wastewater and concentrated oxidant solutions in a mass ratio in the range from 5:1 to 25:1 of oxidant to contaminant.

19. The system of claim 12 wherein the feed system provides for mixing the wastewater and concentrated oxidant solutions in a mass ratio of about 10:1 oxidant to contaminant.

20. The system of claim 12 wherein the second cell operates at a current density from 30 mA/cm² to 200 mA/cm2.
